(19) United States
(12) Patent Application Publication
(10) Pub. No.: US 2005/0100871 A1
(43) Pub. Date: May 12, 2005

(54) Training aid for physical movement with virtual work area

(75) Inventors: Andrew J. Parker, Novato, CA (US); Patricia I. Brenner, Encino, CA (US)

Correspondence Address: FLIESLER MEYER, LLP, FOUR EMBARCADERO CENTER, SUITE 400, SAN FRANCISCO, CA, 94111, US

(73) Assignee: Sharper Image Corporation, San Francisco, CA (US)

(21) Appl. No.: 10/933,055

(22) Filed: Sep. 2, 2004

Related U.S. Application Data
(60) Provisional application No. 60/518,809, filed on Nov. 10, 2003.

(51) Int. Cl. G09B 9/00

(52) U.S. Cl. 434/247; 434/307 R; 434/365

(57) ABSTRACT

A training aid device uses an infrared sensor. The infrared sensor includes an infrared light source to produce pulses of infrared light and optics that focus reflections from the infrared light pulse from different portions of the environment to different detectors in a 2D array of detectors. The detectors produce an indication of the distances of the closest object(s) in the associated portion of the environment. The processor uses the indications from the infrared sensor to compare the user action to a model action. The processor initiates feedback to the user based on the comparison.

### CLAIM OF PRIORITY

This application claims priority to U.S. Provisional Application 60/518,809 filed Nov. 10, 2003.

### FIELD OF THE INVENTION

The present invention relates to training aid devices.

### BACKGROUND

Training aids can be used to teach or improve a physical movement. Examples of training aids include sports trainers, such as golf trainers, dance trainers, tool operation trainers and the like. Computer based training aids can have input devices to receive information concerning the training. Alternately, the training systems can use optical input units, such as video cameras, to detect a user's physical movements.

### BRIEF SUMMARY

One embodiment of the present invention is a training aid device. The training aid device includes an infrared sensor. The sensor includes an infrared light source to produce pulses of infrared light and optics to focus reflections from the infrared light pulse from different portions of the environment to different detectors in a 2D array detector. The detector produces indications of the distance to the closest object in an associated portion of the environment. A processor receives the indication of the infrared sensor to determine the user action. The user action is compared to a model. The processor initiates feedback to the user based upon the comparison.

A training aid device comprises an infrared sensor, the sensor including an infrared light source to produce pulses of infrared light, optics to focus reflections from the infrared light pulse form different portions of the environment to different detectors in a 2D array of detectors, producing indications of the distance to the closest object in an associated portion of the environment and a processor using indications from the infrared sensor to compare a user action to a model action. The processor initiates feedback to the user based on the comparison.

A training method comprises producing pulses of infrared light. Reflections of the infrared light pulses from different portions of the environment are focused to different detectors in a 2D array of detector. At the detectors, indications of the distance to the closest object in associated portion of the environment are produced. The indications from the infrared sensor are used to compare a user action to a model action and to provide feedback to the user based on the comparison.

### BRIEF DESCRIPTION OF THE DRAWINGS

FIG. 1 is a diagram that illustrates a training aid device of one embodiment of the present invention.

FIG. 2 is a diagram that illustrates a cross-sectional view of the operation of an infrared sensor used in a training aid device of one embodiment of the present invention.

FIG. 3 is a diagram that illustrates an examples of reflected pulses used with example of FIG. 2.

FIG. 4 is a diagram that illustrates the operation of a training aid device of one embodiment of the present invention.

### DETAILED DESCRIPTION

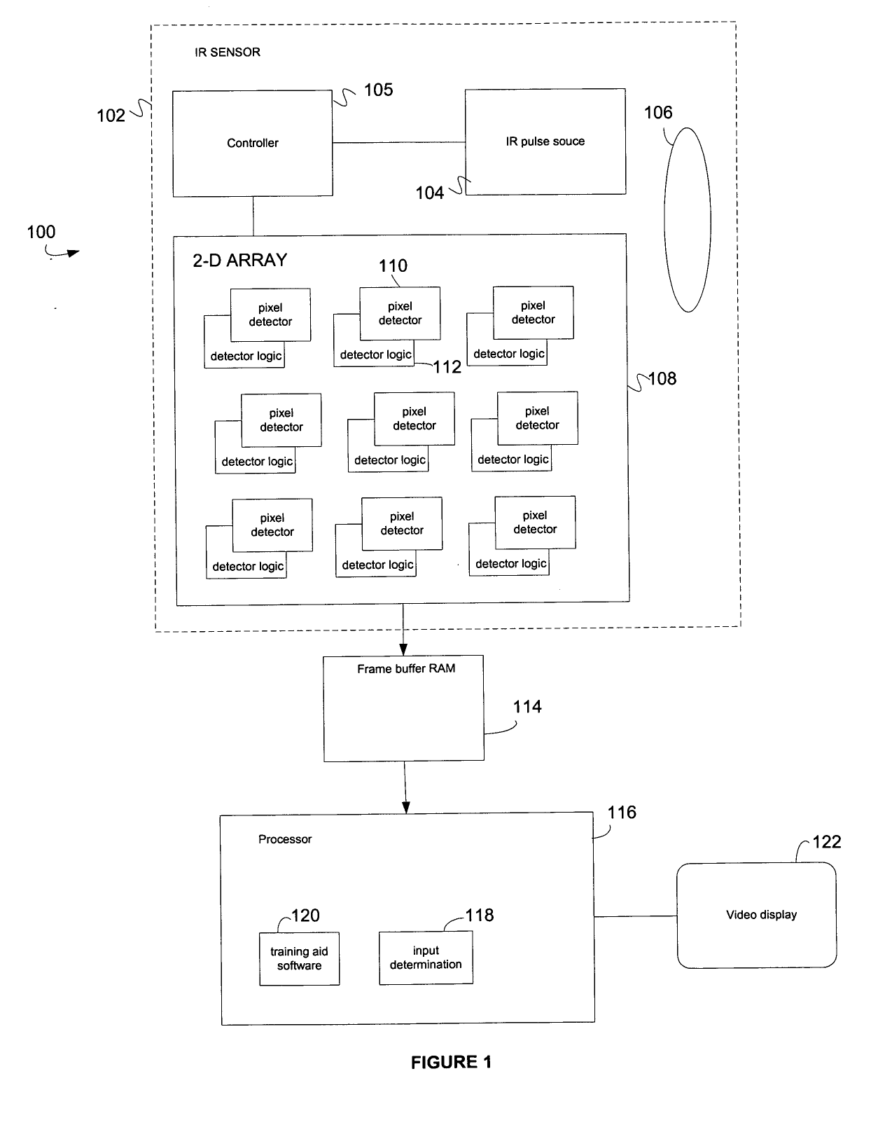

One embodiment of the present invention is training aid device, such as the training aid device 100 shown in FIG. 1. The training aid device can be a computer based system.

An infrared sensor 102 includes an infrared light source 104. The infrared light source 104 can produce pulses of infrared light. An infrared light sensor 102 includes optics 106 to focus reflections from an infrared light source pulse from different portions of the environment to different detectors in a two dimensional (2D) array of the detectors 108. The optics 106 can include a single or multiple optical elements. In one embodiment, the optics 106 focus light reflected from different regions of the environment to the detectors in the 2D array 108. The detectors produce indications of the distances to the closest objects in associated portions of the environment. In the example of FIG. 1, the 2D array includes pixel detectors 110 and associated detector logic 112. In one embodiment, the 2D array of detectors is constructed of CMOS technology on a semiconductor substrate. The pixel detectors can be photodiodes. The detector logic 112 can include counters. In one embodiment, a counter for a pixel detector runs until a reflected pulse is received. The counter value thus indicates the time for the pulse to be sent from the IR sensor and reflected back from an object in the environment to the pixel detector. Different portions of environment with different objects will have different pulse transit times.

In one embodiment, each detector produces an indication of the distance to the closest object in the associated portion of the environment. Such indications can be sent from the 2D detector array 108 to a memory such as the Frame Buffer RAM 114 that stores frames of the indications. A frame can contain distance indication data of the pixel detectors for a single pulse.

Controller 105 can be used to initiate the operation of the IR pulse source 104 as well as to control the counters in the 2D detector array 108.

An exemplary infrared sensor for use in the present invention is available from Canesta, Inc. of San Jose, Calif. Details of such infrared sensors are described in the U.S. Pat. No. 6,323,932 and published patent applications US 2002/0140633 A1, US 2002/0063775 A1, US 2003/0076484 A1 each of which are incorporated herein by reference.

The processor 116 can receive the indications from the infrared sensor 102. A user action can be determined from the two dimensional distance indications. The processor can use the indications from the infrared sensor to compare a user action to a model actions. The frames give an indication of a user actions, such as the position or orientation of a users hand, feet or other body part or of a tool used by the user. The indications can be compared to a stored indication of a model action.

In one embodiment, the indications are used to get a determination of the orientation and position of a body part or tool. Once an abstract determination of the body part orientation and position is produced, the determined information can be compared to a model action. For example, if the model action concerns a golf swing, the position and orientation of the arm or golf clubs within the field of view of the infrared sensor is determined. During a swing, the user action is compared to a stored model action, which can be an abstract model of the action.

In another embodiment, the model action can contain more details and could be for example, previously produced indication data or ideal indication data. By doing the comparison, suggested changes to the orientation and/or position of body parts on a tool can be produced.

In one embodiment, feedback is provided to the user based upon the comparison. The processor 116 can initiate the feedback to the user. In one embodiment, the feedback is a video display 122, which produces a visual indication of a suggested improvement in the user body part of tool position orientation. In another embodiment, the feedback is a sound, such as a warning sound.

In one embodiment, the training method is body movement training. The body movement training can be, for example, dance training so that the training system can teach the user dance moves. In another embodiment, the training is a sports training wherein the training method teaches the user how to do certain sports or sports actions. In one embodiment, the training is a tool operation training. The tool operation training can be the operation of tools such as golf club or other tool that has a preferred method of operation. In one embodiment, the model action includes body part position information. The body part position information can be useful in teaching a user how to correctly position the user's body during certain operation. In another embodiment, the model action includes body part orientation information. This body part orientation information can be useful during the training to determine the correct orientation of the user.

In one embodiment, the comparison compares the user's actions to a model action where the model action and comparison can have multiple stages. The movement from one stage to another can be done based on elapsed time or the user completing a portion of the model action. Alternately, if the user action is close to a model action for a stage, a comparison to that model action stage can be triggered. In one example, the user action can be compared to actions for multiple stages.

In one example, the training can be work training in which the user is trained to do certain actions on an assembly line or other workplace. Each stage in the model action can be timed to portion of the assembly line.

In example of FIG. 1, the indication of the object distances are stored in frames in the Frame Buffer RAM 114 then provided to the processor 106.

In the example of FIG. 1, input determination code 118 running on the processor 116 can determine the features of a user action based on the indications.

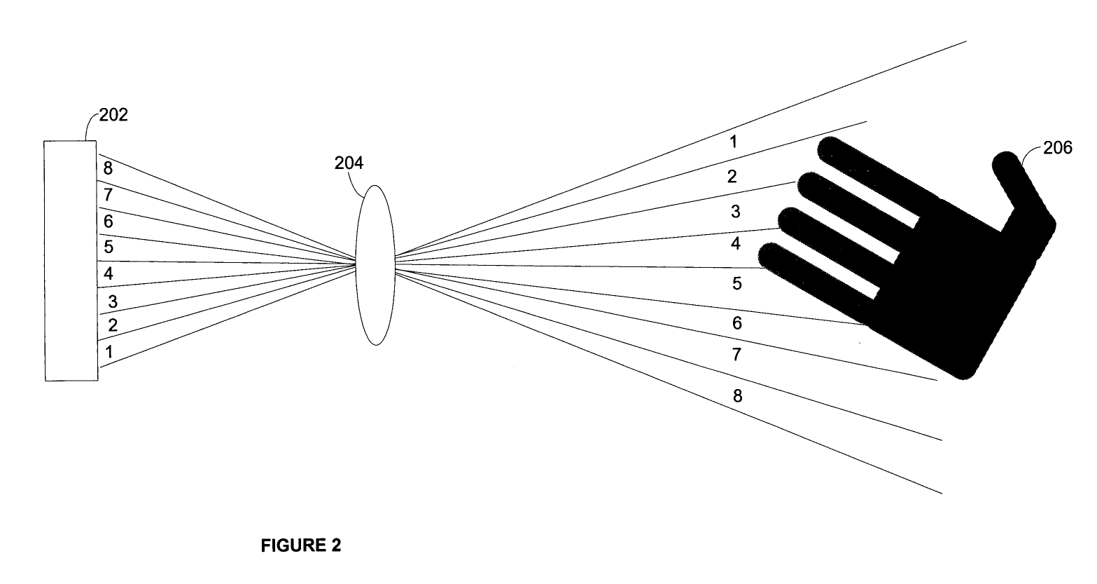

FIG. 2 illustrates the operation of a cross-section of the 2D detector array. In the example of FIG. 2, the 2D array detectors 206 and optics 204 are used to determine the location of the object 206 within the environment. In this example, reflections are received from regions 2, 3, 4, 5 and 6. The time to receive these reflections can be used to determine the position of the closest object within the region of the environment.

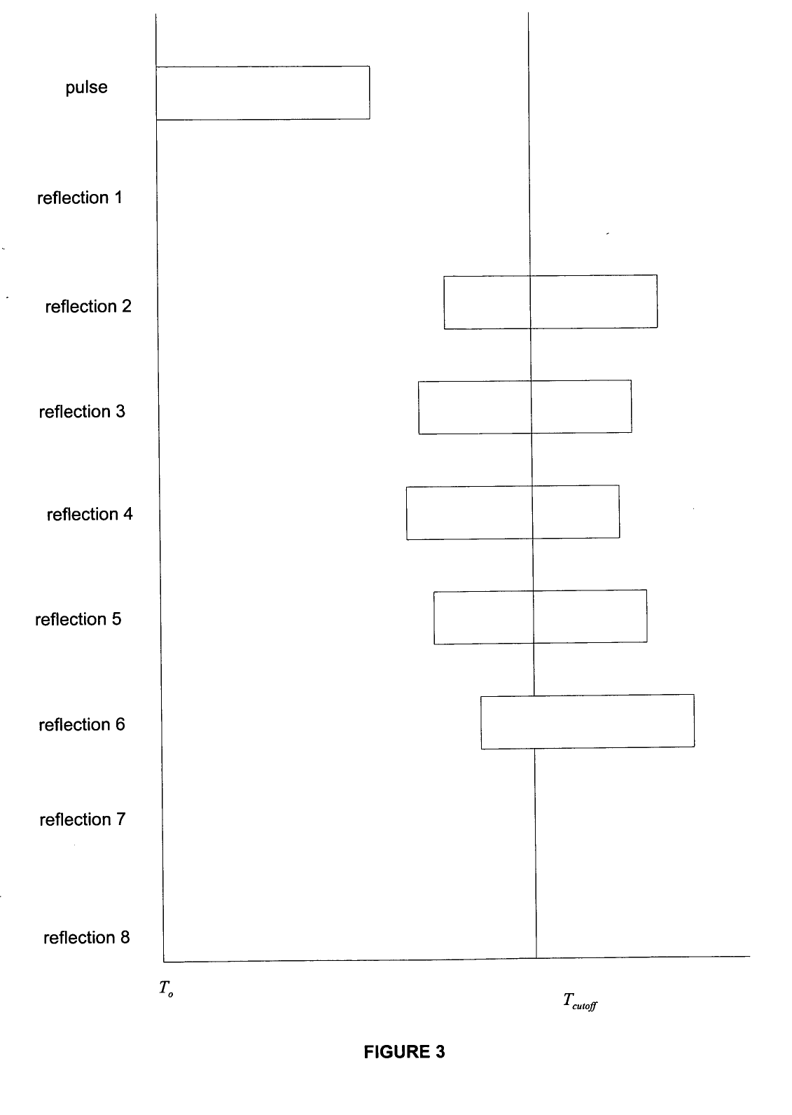

In the example of FIG. 3, a pulse is created and is sent to all of the regions 1 to 8 shown in FIG. 2. Regions 1, 7 and 8 do not reflect the pulses to the sensor; regions 2, 3, 4, 5 and 6 do reflect the pulses to the sensor. The time to receive the reflected pulse can indicate the distance to an element.

In one embodiment, the system measures the reflected pulse duration or energy up to a cutoff time, t_{cutoff}. This embodiment can reduce detected noise in some situations.

In one embodiment, the input device examines the position of the users arm, hand or other object placed within a operating region of the infrared sensor. The distance indications from the 2D detector give a two-dimensional map of the closest object within the different portions of the environment. Different regions within the operating region of the infrared sensor can have different meanings. For example, in boxing trainer, a fist may need to go a certain distance within a two dimensional region to be considered a hit. In one example, a number of the pixel detectors correspond to a torso locations imagined to be a specific distance from the infrared sensor. If a fist reaches the pixel detector locations corresponding to the distance to the torso, a hit can be scored. The regions such as the torso locations can be actively modified in the video game. Defensive positioning of the users hands can also be determined and can thus affect the gameplay.

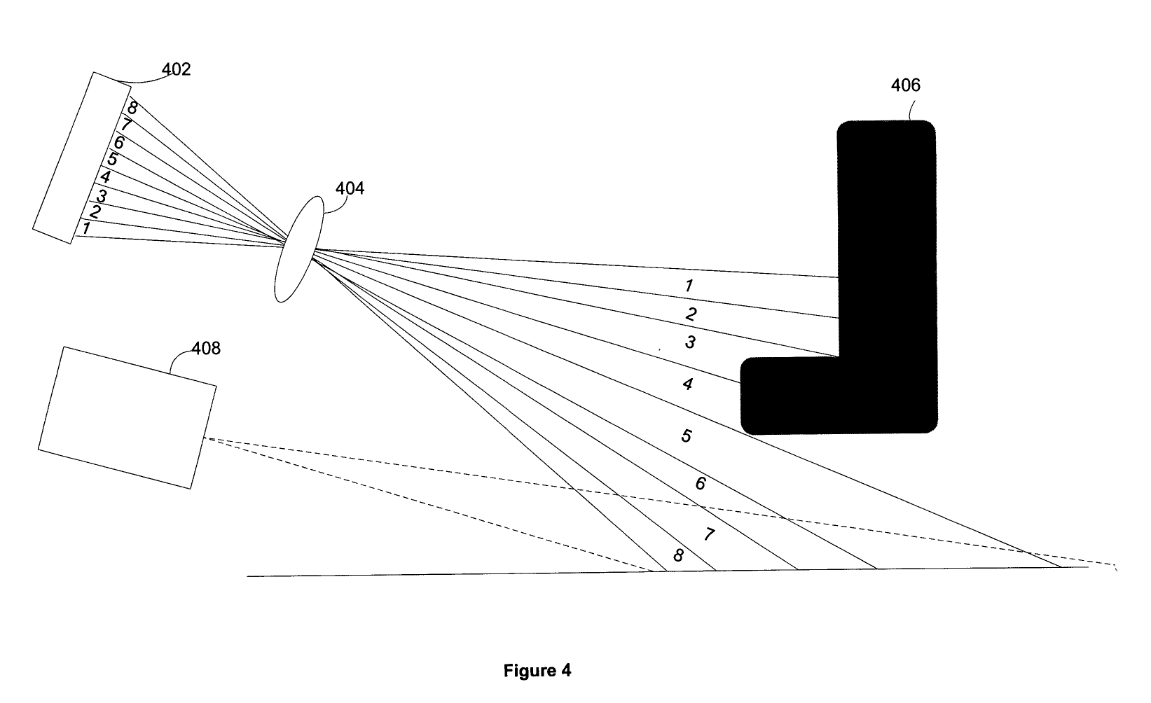

Feedback can be indicted on display 112. FIG. 4 illustrates an alternate embodiment of the present invention. In this embodiment, a display generator 408 can be used to produce an indication on a surface. The indication can be for example, a feet position location used in a dance. The two dimensional array 408 and optics 404 can be used to determine whether a user's foot is correctly positioned at the displayed foot location. As an alternative to the light display, a foot pad or some other indication can be used.

In one embodiment, body parts, shape or changes in the movement of the user's hands or other object can be associated with an input. The distance indications can be used to be determine the location of an object or a location of a hand. Changes in the position and orientation of the hand can be determined and used as input. For example, a fist can have a one input value, a palm face forward can have another input value, a handshake position yet another input value. Movement of the hand up, down, left, right in out can have other input values.

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

1. A training aid device comprising:
an infrared sensor, the sensor including an infrared light source to produce pulses of infrared light, optics to focus reflections from the infrared light pulses from different portions of the environment to different detectors in a 2D array of detectors, the detectors producing indications of distances to the closest object in an associated portion of the environment; and
a processor using the indications from the infrared sensor to compare a user action to a model action, the processor initiating feedback to the user based on the comparison.

2. The training aid device of claim 1, wherein the feedback uses a video display.

3. The training aid device of claim 1, wherein the feedback uses sound.

4. The training aid device of claim 1, wherein the training is body movement training.

5. The training device of claim 4, wherein the training is dance training.

6. The training device of claim 1, wherein the training is training is tool operation training.

7. The training device of claim 1, wherein the model action includes body part position information.

8. The training device of claim 1, wherein the model action includes body part orientation information.

9. A training method comprising:
producing pulses of infrared light;
focusing reflections of the infrared light pulse from different portions of the environment to different detectors in a 2D array of detectors;
at the detectors, producing indications of the distances to the closest object in associated portions of the environment; and
using the indications from the infrared sensor to compare a user action to a model action; and
providing feedback to the user based on the comparison.

10. The training method of claim 1, wherein the feedback uses a video display.

11. The training method of claim 1, wherein the feedback uses sound.

12. The training method of claim 1, wherein the training is body movement training.

13. The training method of claim 4, wherein the training is dance training.

14. The training method of claim 1, wherein the training is tool operation training.

15. The training method of claim 1, wherein the model action includes body part position information.

16. The training method of claim 1, wherein the model action includes body part orientation information.
